(19) United States
(12) Patent Application Publication
(10) Pub. No.: US 2014/0123762 A1
(43) Pub. Date: May 8, 2014

(54) LASER APPARATUS AND PHOTOACOUSTIC APPARATUS USING LASER APPARATUS

(71) Applicant: CANON KABUSHIKI KAISHA, Tokyo (JP)

(72) Inventors: Yukio Furukawa, Sagamihara-shi (JP); Shigeru Ichihara, Tokyo (JP)

(73) Assignee: CANON KABUSHIKI KAISHA, Tokyo (JP)

(21) Appl. No.: 14/068,150

(22) Filed: Oct. 31, 2013

(30) Foreign Application Priority Data
Nov. 8, 2012 (JP) 2012-246411

(51) Int. Cl. H01S 3/10; G01H 9/00

(52) U.S. Cl. CPC H01S 3/10; G01H 9/00
USPC 73/655; 372/20

(57) ABSTRACT

A laser apparatus comprises a cavity having an output unit, and a branch unit arranged between the output unit and first and second reflection unit, an optical path in the cavity including a common part and separate parts, respectively; a laser medium and a wavelength filter disposed in the common part; a pump unit configured to pumping the laser medium; and first and second shielding units respectively disposed in the first and second separate parts, the transmittance of the wavelength filter is varied based on the wavelength and polarization of incident light, the branch unit splits a light beam into the first polarized light and the second polarized light, and one of the first and second shielding units being opened and the other closed to select one of the wavelengths of light to be emitted.

### BACKGROUND OF THE INVENTION

1. Field of the Invention

The present invention relates to a laser apparatus and a photoacoustic apparatus that uses the laser apparatus.

2. Description of the Related Art

Optical imaging apparatuses that irradiate a living body with light from a light source such as a laser and visualize in-vivo information that is obtained from the projected light are being actively researched for use in medical applications. Photoacoustic tomography (PAT) is one of such optical imaging techniques. A PAT apparatus projects light pulses generated from a light source to a living body and detects acoustic waves that a biological tissue generates upon absorbing the energy of the light pulses having propagated and diffused through the living body. This generation of photoacoustic waves is called photoacoustic effect, and an acoustic wave generated by the photoacoustic effect is called a photoacoustic wave.

A segment of the object such as a tumor often has a higher light energy absorption rate than surrounding tissues, so that it absorbs more light than the surrounding tissues and expands instantaneously. Photoacoustic waves generated by this expansion are detected by an acoustic wave detector to obtain signals. The received signals are mathematically analyzed and processed to generate an image of a sound pressure distribution based on the photoacoustic waves generated inside the object (hereinafter referred to as a “photoacoustic image”). An in-vivo optical characteristics distribution, in particular, an absorption coefficient distribution, can be obtained based on such photoacoustic images. Such information may be used for quantitative measurement of specific substances inside the object, for example, glucose or hemoglobin in blood. Recent years have seen active research on photoacoustic apparatuses to be used for the purpose of generating an image of blood vessels of a small animal, or for the diagnosis of breast cancer or the like, with the use of PAT.

Substances in a living body such as glucose or hemoglobin have different light absorption rates depending on the wavelength of incident light. Therefore, a distribution of a substance in a living body can be determined more precisely by irradiating the object with light of different wavelengths and by analyzing the difference in the absorption coefficient distribution. A wavelength range of 500 nm to 1200 nm is generally used for this light. If absorption by melanin or water needs to be avoided, in particular, near-infrared light of a wavelength range of 700 nm to 900 nm is used.

Titanium sapphire lasers and alexandrite lasers are tunable solid-state lasers that have a gain band in the wavelength ranges mentioned above.

Some wavelength selection mechanisms for tunable lasers adopt a method of rotating a mirror in a laser oscillator having a dispersive component such as a prism or diffraction grating arranged therein, or a method of rotating a birefringent plate disposed in a laser oscillator, and others use an acousto-optical element (see Japanese Patent No. 3567234).

Mechanical rotation of an optical component for the selection of wavelength involves the problem of a possible drop of output energy or wavelength displacement caused by a misalignment of rotation axis and a resultant misalignment of optical axis.

According to the method described in Japanese Patent No. 3567234, a desired wavelength can be selected without using a mechanical moving mechanism. More specifically, a laser medium capable of outputting laser light of a predetermined wavelength band and an acousto-optical element are disposed in a laser oscillator, with a mirror arranged on a predetermined optical axis of a light beam component diffracted by the acousto-optical element. The wavelength of light diffracted toward the mirror can be controlled by selecting a frequency of acoustic wave to be generated in the acousto-optical element, which allows for selection of wavelength of the light to be emitted. That is, a desired wavelength can be selected without using a mechanical rotation mechanism, by applying RF ultrasound signals to the acousto-optical element.

However, one problem with the acousto-optical element is large intracavity loss because of its diffraction efficiency being normally 70% to 80%, even with primary diffraction light. Also, acousto-optical elements can hardly be applied to a high power laser apparatus because of their limited light resistance.

### SUMMARY OF THE INVENTION

The present invention was made in view of the problems described above, its object being to provide a technique that allows stable wavelength selection and laser oscillation in a tunable laser apparatus.

The present invention in its one aspect provides a laser apparatus comprising a cavity having an output unit, and a branch unit arranged between the output unit and first and second reflection units, an optical path in the cavity including a common part between the output unit and the branch unit and separate parts between the branch unit and the first and second reflection units, respectively; a laser medium and a wavelength filter disposed in the common part; a pump unit configured to pumping the laser medium; and first and second shielding units respectively disposed in the first and second separate parts configured to allowing selection of one of a first wavelength and a second wavelength of light to be emitted, the wavelength filter having a higher transmittance of first polarized light than second polarized light when the first polarized light of the first wavelength is incident, and a lower transmittance of the first polarized light than the second polarized light when the first polarized light of the second wavelength is incident, the branch unit splits a light beam into the first polarized light and the second polarized light, and one of the first and second shielding units being opened and the other closed to select one of the wavelengths of light to be emitted.

The present invention can provide a technique that allows stable wavelength selection and laser oscillation in a tunable laser apparatus.

Further features of the present invention will become apparent from the following description of exemplary embodiments with reference to the attached drawings.

### BRIEF DESCRIPTION OF THE DRAWINGS

FIG. 1A and FIG. 1B are schematic diagrams for explaining a first embodiment;

FIG. 2A to FIG. 2C are diagrams for explaining a first resonance condition in the first embodiment;

FIG. 3A to FIG. 3C are diagrams for explaining the first resonance condition in the first embodiment;

FIG. 4A to FIG. 4C are diagrams for explaining a second resonance condition in the first embodiment;

FIG. 5A to FIG. 5C are diagrams for explaining the second resonance condition in the first embodiment;

FIG. 6A and FIG. 6B are schematic diagrams for explaining a second embodiment;

FIG. 7A to FIG. 7C are diagrams for explaining a first resonance condition in the second embodiment;

FIG. 8A to FIG. 8C are diagrams for explaining the first resonance condition in the second embodiment;

FIG. 9A to FIG. 9C are diagrams for explaining a second resonance condition in the second embodiment;

FIG. 10A to FIG. 10C are diagrams for explaining the second resonance condition in the second embodiment;

FIG. 11A and FIG. 11B are schematic diagrams for explaining a third embodiment;

FIG. 12A to FIG. 12C are diagrams for explaining a first resonance condition in the third embodiment;

FIG. 13A to FIG. 13C are diagrams for explaining a second resonance condition in the third embodiment;

FIG. 14A to FIG. 14C are schematic diagrams for explaining a fourth embodiment;

FIG. 15A and FIG. 15B are schematic diagrams for explaining a fifth embodiment;

FIG. 16A to FIG. 16C are diagrams for explaining a wavelength filter in the fifth embodiment; and

FIG. 17 is a schematic diagram for explaining a sixth embodiment.

### DESCRIPTION OF THE EMBODIMENTS

Preferred embodiments of the present invention will be hereinafter described with reference to the drawings. Note, it is not intended to limit the scope of this invention to the specifics given below, and the sizes, materials, shapes, and relative arrangements or the like of constituent components described below should be changed as required in accordance with the configurations and various conditions of the apparatus to which the invention is applied.

The present invention can be understood as a tunable laser apparatus, and a control method of the same. The present invention can be applied to a photoacoustic apparatus including such a laser apparatus as one constituent element. Namely, an apparatus having the laser apparatus according to the present invention to irradiate an object with a laser beam to obtain a photoacoustic wave that is generated from a light absorbing part inside the object by the photoacoustic effect and propagates through the object. With the use of the laser apparatus according to the present invention, the wavelength of light emitted to the object can be changed simply in a stable manner, so that presence of various tissues (light absorbing parts) having different light absorption characteristics can be identified as property information. The obtained information can be displayed to be used for diagnosis. Property information may be, for example, a distribution of oxygen saturation determined by emitting light of wavelengths corresponding to the absorption characteristics of oxyhemoglobin and deoxyhemoglobin, which may be used for the detection of angiogenesis.

The acoustic waves referred to in the present invention are typically ultrasound waves, including elastic waves that are called sound waves, ultrasound waves, or acoustic waves. An acoustic wave generated by the photoacoustic effect is referred to as a “photoacoustic wave”, or a “light-induced ultrasound wave”.

<Constituent Elements of the Apparatus>

The laser apparatus according to the present invention will be described below. The functions of various constituent elements of the laser apparatus will be described first, after which each embodiment will be described with reference to the drawings.

(Output Coupler)

An output coupler extracts a portion of the light from an optical cavity and reflects back the remaining light; it is a mirror having an appropriate reflectivity to the light of a desired wavelength. The output coupler is also called an outcoupling mirror and corresponds to an “output unit” in the definition of the present invention. A cavity is formed by the following elements, with an output coupler and a rear mirror to be described later arranged at both ends. More particularly, a first cavity is formed by the output coupler and a first rear mirror, and a second cavity is formed by the output coupler and a second rear mirror.

(Laser Medium)

If the object is a living body, it is desirable to emit light of a wavelength that will be absorbed by a specific one of components constituting the living body, and the laser medium needs to have a gain in a region including this wavelength. If absorption by melanin or water needs to be avoided, in particular, it is preferable to use a laser medium that can emit near-infrared light of a wavelength of 700 nm to 900 nm. Titanium sapphire crystal and alexandrite crystal can be used as a laser medium that provides a gain in such a band of wavelengths. Alternatively, pigments may be used. A crystal laser medium may be processed to have an end face at a Brewster's angle so that p-polarized light will be predominantly oscillated. If the light is incident perpendicularly, the laser medium may be provided with anti-reflection coating that prevents reflection of light of a desired wavelength.

(Wavelength Filter)

A wavelength filter is a filter with transmission characteristics corresponding to the wavelengths of light emitted from the laser medium. More specifically, the wavelength filter is formed by one or a plurality of birefringent plate(s) made of uniaxial crystal (such as quartz) processed to have the optical axis parallel to the plate surface.

The wavelength filter has the following functions.

The transmittance of a first incident polarized light beam (e.g., p-polarized light) of a first wavelength is higher than the transmittance of a second polarized light beam (e.g., s-polarized light) perpendicular to the first polarized light beam.

The transmittance of the first incident polarized light beam of a second wavelength is lower than the transmittance of the second polarized light beam.

The birefringent plate forming the wavelength filter has a thickness and optical axis orientation that fulfill the functions above.

The thickness (“predetermined thickness”) determines the basic function of the birefringent plate; it is set such that the phase difference between an ordinary ray and an extraordinary ray of the first wavelength propagating through the birefringent plate will be an even multiple of 180°, and that the phase difference between an ordinary ray and an extraordinary ray of the second wavelength will be an odd multiple of 180°. If the wavelength filter is formed by a plurality of birefringent plates, the plate closest a polarizing beam splitting element may have a thickness that is an odd multiple of a basic thickness, and other plates may have a thickness that is an even multiple of the basic thickness, to fulfill the functions above.

The wavelength filter is set at an angle such that light to be resonated is incident perpendicularly or at the Brewster's angle. If the light is incident perpendicularly, it is desirable to provide anti-reflection coating on both faces of the birefringent plate that forms the wavelength filter. If the filter is made from a plurality of birefringent plates, it is desirable to insert a polarizing plate that allows transmission of only the first polarized light (e.g., p-polarized light) between the birefringent plates.

(Polarizing Beam Splitting Element)

A polarizing beam splitting element is a component that splits a light beam into a first polarized light beam (e.g., p-polarized light) and a second polarized light beam (e.g., s-polarized light). Polarizing beam splitter cubes or plate-like polarizing beam splitters that split a light beam at 90° may preferably be used. Other prisms that transmit the ordinary ray and the extraordinary ray at different angles such as a Glan-laser prism, a Wollaston prism, and a Rochon prism, may also be used. The polarizing beam splitting element branches the cavity into a first cavity and a second cavity. The polarizing beam splitting element corresponds to “branch unit” in the definition of the present invention. The portion of the optical path inside the cavity from the output coupler to the polarizing beam splitting element is called a common part. The portion of the optical path from the polarizing beam splitting element to the first rear mirror is called a first separate part, and the portion of the optical path from the polarizing beam splitting element to the second rear mirror is called a second separate part. The first cavity consists of the common part and the first separate part, while the second cavity consists of the common part and the second separate part.

(Rear Mirror)

The rear mirror is a component arranged in the separate part of the first and second cavities for reflecting light, i.e., there are a first mirror and a second mirror. These mirrors are generally made of multiple layers of dielectric material having a reflectivity of 95% or more. The rear mirror is also called a reflective mirror and corresponds to a “reflection unit” in the definition of the present invention.

(Light Shielding Means)

The light shielding means is a component arranged in the separate part of the first and second cavities for interrupting the light beam, i.e., there are first light shielding means and second light shielding means. Optical shutters that are mechanically opened and closed may favorably be used. Alternatively, a combination of an electro-optical element and a polarizing plate may be used, whereby the polarization of transmitted light is controlled by application of an electric field to the electro-optical element. Alternatively, the rear mirrors may be mounted on a slidable stage and moved by sliding the stage to interrupt the optical path. The light shielding means corresponds to the first and second shielding units in the definition of the present invention.

With the first light shielding means opened and the second light shielding means closed, a laser beam is output from the first cavity. With the first light shielding means closed and the second light shielding means opened, a laser beam is output from the second cavity. When the cavity is “open”, it is capable of resonating, while when it is “closed” (when the optical path is interrupted), the cavity is incapable of resonating. Thus a wavelength can be selected by making one of the light shielding means “open” and the other “closed”.

<Operation of the Apparatus>

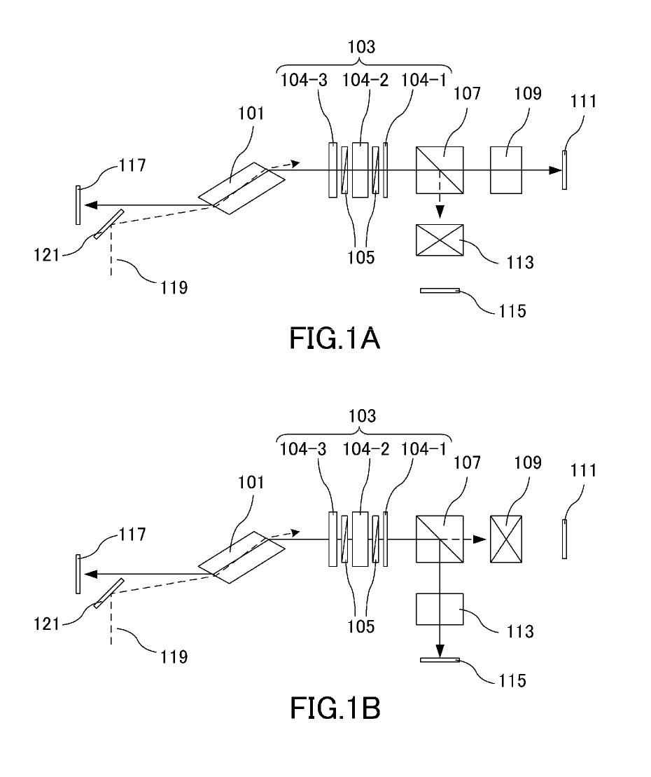

How the laser apparatus of the present invention operates will be described below with reference to FIG. 1A and FIG. 1B.

An output coupler 117, a laser medium 101, a wavelength filter 103, and a polarizing beam splitting element 107 are arranged in this order. These are the common part of the first and second cavities.

The wavelength filter is designed such that p-polarized incident light of a first wavelength transmits as a p-polarized light beam, and p-polarized incident light of a second wavelength transmits as an s-polarized light beam.

The polarizing beam splitting element 107 is designed such as to transmit p-polarized light and reflect s-polarized light.

A first rear mirror 111 and first light shielding means 109 are arranged in the first cavity, while a second rear mirror 115 and second light shielding means 113 are arranged in the second cavity. The first cavity has the output coupler 117 and the first rear mirror 111 arranged at both ends, and the second cavity has the output coupler 117 and the second rear mirror 115 arranged at both ends.

The first cavity is made effective when the first light shielding means 109 is open and the second light shielding means 113 is closed, as shown in FIG. 1A. P-polarized light entering the wavelength filter 103 from the left side transmits the filter as a p-polarized light beam at the first wavelength, and as an s-polarized light beam at the second wavelength. P-polarized light of the first wavelength transmits the polarizing beam splitting element 107, is reflected by the first rear mirror 111, transmits the polarizing beam splitting element 107 again, enters the wavelength filter 103 from the right side as a p-polarized light beam, and transmits the filter as a p-polarized light beam. That is, the light of the first wavelength can resonate in the first cavity. On the other hand, s-polarized light of the second wavelength is reflected by the polarizing beam splitting element 107 and interrupted by the second light shielding means so that it does not resonate. Therefore, in this state, a light beam of the first wavelength is emitted.

The second cavity is made effective when the first light shielding means 109 is closed and the second light shielding means 113 is open, as shown in FIG. 1B. P-polarized light entering the wavelength filter 103 from the left side transmits the filter as a p-polarized light beam at the first wavelength, and as an s-polarized light beam at the second wavelength. P-polarized light of the first wavelength transmits the polarizing beam splitting element 107 and is interrupted by the first light shielding means 109. On the other hand, s-polarized light of the second wavelength is reflected by the polarizing beam splitting element 107, reflected by the second rear mirror 115, reflected by the polarizing beam splitting element 107 again, enters the wavelength filter 103 from the right side as an s-polarized light beam, is converted into a p-polarized light beam, and transmits the filter. That is, the light of the second wavelength can resonate in the second cavity. Therefore, in this state, a light beam of the second wavelength is emitted.

Thus the wavelengths can be changed only by opening and closing the first and second light shielding means without the need to mechanically rotate optical components such as mirrors in the cavities, and laser pulses can therefore be output stably.

The laser configuration will be described in more detail in the following examples of embodiment.

### Embodiment 1

A laser apparatus according to a first embodiment will be described further with reference to FIG. 1A and FIG. 1B. Reference numeral 101 in the drawing denotes a laser medium made of titanium sapphire crystal that is cut to have an end face at the Brewster's angle relative to resonating light. Reference numeral 103 denotes a wavelength filter that is formed by three birefringent plates 104-1, 104-2, and 104-3, and two polarizing plates 105. Reference numeral 107 denotes a polarizing beam splitting element which is a polarizing beam splitter that transmits p-polarized light and reflects s-polarized light. Reference numeral 109 denotes first light shielding means which is an optical shutter provided to the first cavity. Reference numeral 111 denotes a first rear mirror having a reflectivity of 99%. Reference numeral 113 denotes second light shielding means which is an optical shutter provided to the second cavity. Reference numeral 115 denotes a second rear mirror having a reflectivity of 99%. Reference numeral 117 denotes an output coupler having a reflectivity of 50%. Reference numeral 119 denotes a pump light beam which is a second high-frequency light beam of a YAG laser (not shown), and reference numeral 121 denotes a mirror for guiding the pump light beam 119 toward the laser medium 101.

The configuration of the wavelength filter 103 will be described in more detail below.

The birefringent plate 104-1 is made of quartz crystal having the optical axis perpendicular to the thickness direction and a thickness of 0.7 mm (equal to one time the “predetermined thickness”). When light of wavelength 799 nm (“first wavelength”) transmits the birefringent plate 104-1, an ordinary ray and an extraordinary ray have a phase difference of an even multiple of 180°, and when light of wavelength 752 nm (“second wavelength”) transmits the birefringent plate, an ordinary ray and an extraordinary ray have a phase difference of an odd multiple of 180°. The birefringent plate 104-2 is made of quartz crystal having the optical axis perpendicular to the thickness direction and a thickness of 2.8 mm (equal to four times the “predetermined thickness”). The birefringent plate 104-3 is made of quartz crystal having the optical axis perpendicular to the thickness direction and a thickness of 1.4 mm (equal to two times the “predetermined thickness”).

The birefringent plates 104-1, 104-2, and 104-3 each have anti-reflection coating (not shown) on their faces. The birefringent plates 104-1, 104-2, and 104-3 are all arranged parallel so that their optical axes are oriented in the same direction. Provided that the direction parallel to the paper plane is the electric field direction of p-polarized light, covering the angles from 0° to 180°, and the direction vertical to the paper plane is the electric field direction of s-polarized light, covering the angles from 90° to 270°, the birefringent plates are arranged such that their optical axes are oriented in the direction of 45°. Polarizing plates 105 that transmit only p-polarized light are interposed between adjacent birefringent plates.

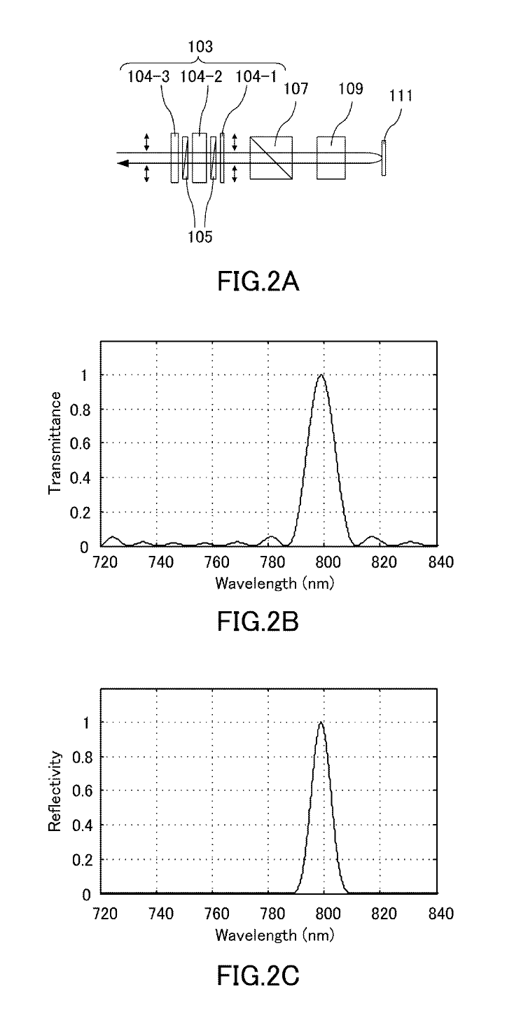

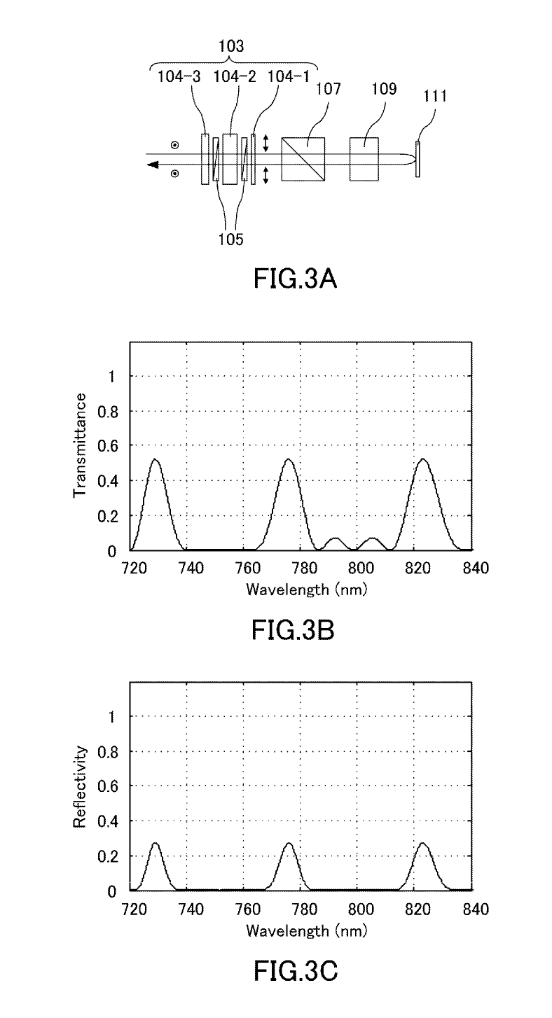

FIG. 1A is a schematic diagram of a state in which the first light shielding means 109 is open and the second light shielding means 113 is closed. The properties the wavelength filter 103 exhibits at this time will be described with reference to FIGS. 2A to 2C and FIGS. 3A to 3C. FIG. 2A shows part of FIG. 1A.

FIG. 2B shows the power transmittance of p-polarized light through the wavelength filter 103 when p-polarized light is incident from the left side of the wavelength filter 103 in FIG. 2A. FIG. 2C shows the power reflectivity of p-polarized light that has entered the wavelength filter 103, traveled via the polarizing beam splitting element 107 and the first rear mirror 111, and is emitted from the wavelength filter 103.

FIGS. 2B and 2C indicate that light of wavelength 799 nm can resonate most efficiently.

FIG. 3A shows part of FIG. 1A. FIG. 3B shows the power transmittance of p-polarized light through the wavelength filter 103 when s-polarized light is incident from the left side of the wavelength filter 103 in FIG. 3A. FIG. 3C shows the power reflectivity of s-polarized light that has entered the wavelength filter 103, traveled via the polarizing beam splitting element 107 and the first rear mirror 111, and is emitted from the wavelength filter 103.

FIG. 3B and FIG. 3C indicate that an s-polarized light beam of around 776 nm, for example, can resonate, but since the reflectivity is 30% or less, the oscillation threshold is higher than the case shown in FIGS. 2A to 2C. The laser medium (crystal) 101 has an end face processed to be at the Brewster's angle, so that the reflection loss of s-polarized light is higher than that of p-polarized light.

Accordingly, in the state shown in FIG. 1A, a laser beam of around 799 nm is output.

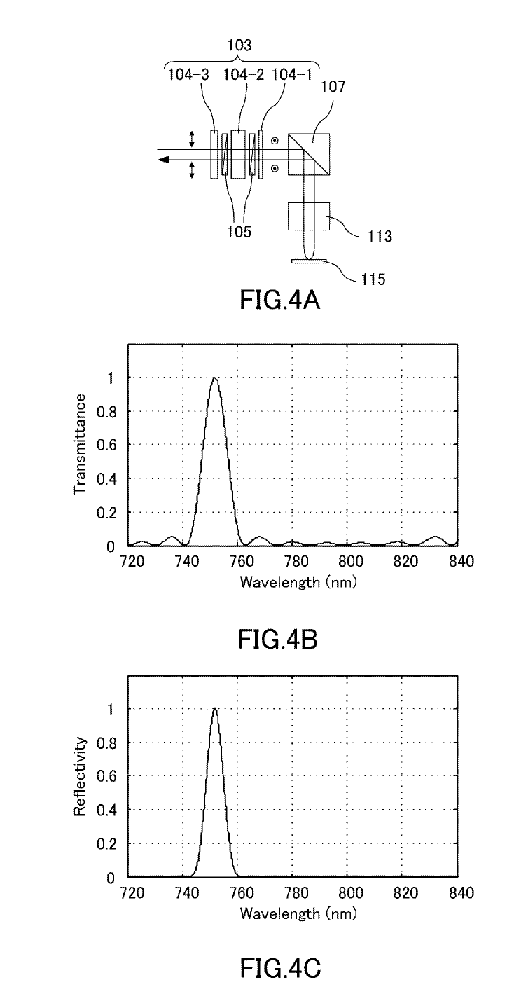

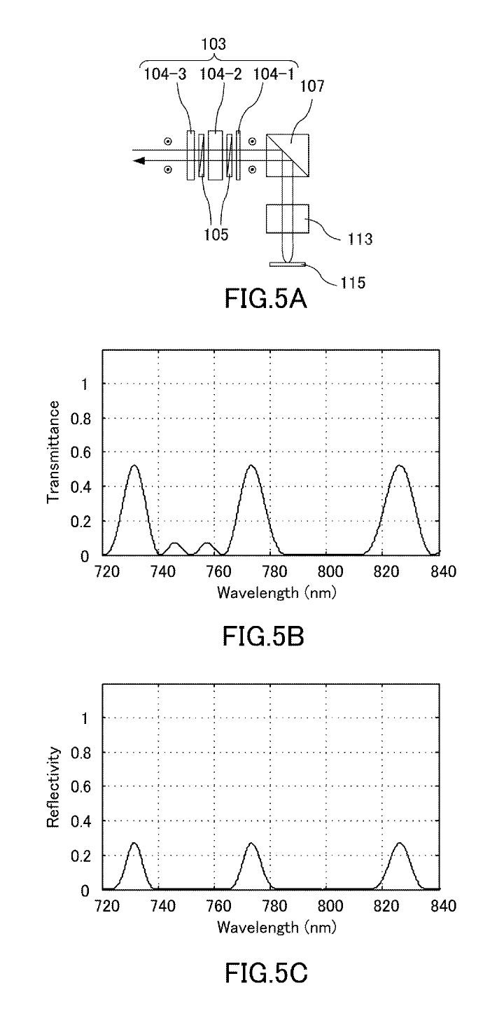

FIG. 1B is a schematic diagram of a state in which the first light shielding means 109 is closed and the second light shielding means 113 is open. The properties the wavelength filter 103 exhibits at this time will be described with reference to FIGS. 4A to 4C and FIGS. 5A to 5C.

FIG. 4A shows part of FIG. 1B. FIG. 4B shows the power transmittance of s-polarized light through the wavelength filter 103 when p-polarized light is incident from the left side of the wavelength filter 103 in FIG. 4A. FIG. 4C shows the power reflectivity of p-polarized light that has entered the wavelength filter 103, traveled via the polarizing beam splitting element 107 and the second rear mirror 115, and is emitted from the wavelength filter 103.

FIGS. 4B and 4C indicate that light of wavelength 752 nm can resonate most efficiently.

FIG. 5A shows part of FIG. 1B. FIG. 5B shows the power transmittance of s-polarized light through the wavelength filter 103 when s-polarized light is incident from the left side of the wavelength filter 103 in FIG. 5A. FIG. 5C shows the power reflectivity of s-polarized light that has entered the wavelength filter 103, traveled via the polarizing beam splitting element 107 and the second rear mirror 115, and is emitted from the wavelength filter 103.

FIG. 5B and FIG. 5C indicate that an s-polarized light beam of around 773 nm, for example, can resonate, but since the reflectivity is 30% or less, the oscillation threshold is higher than the case shown in FIGS. 4A to 4C. The laser medium (crystal) 101 has an end face processed to be at the Brewster's angle, so that the reflection loss of s-polarized light is higher than that of p-polarized light. Accordingly, in the state shown in FIG. 1B, a laser beam of around 752 nm is output.

As described above, two wavelengths (799 nm and 752 nm) can be switched between one another only by opening and closing the first and second light shielding means 109 and 113.

If the pump light beam 119 is given as light pulses, the first and second light shielding means 109 and 113 may be controlled to open and close in synchronism with the frequency of the pulses. The wavelengths can be switched per each pulse, for example.

According to the present invention, as described above, a tunable laser apparatus capable of stable laser output can be realized without using an acousto-optical element that causes large intracavity losses and has limited light resistance, and without using a mechanical moving mechanism.

### Embodiment 2

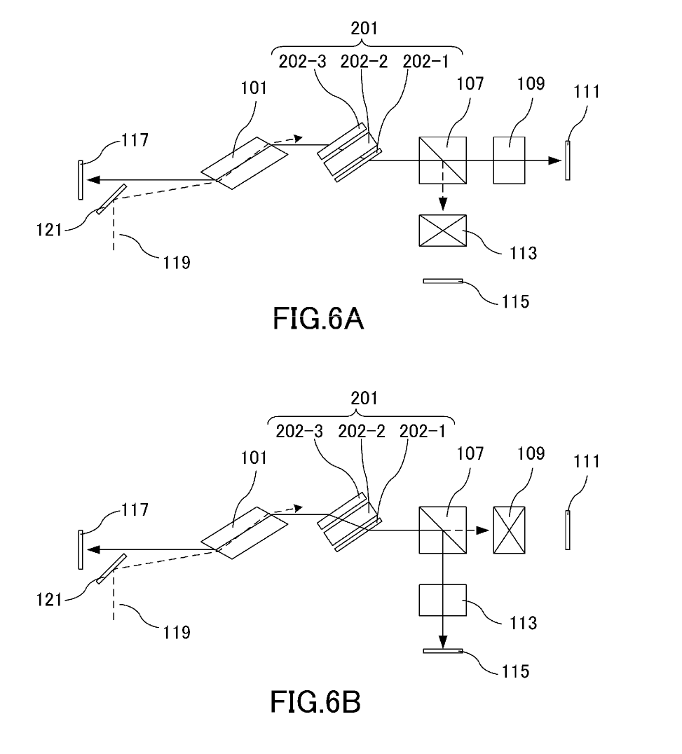

FIGS. 6A and 6B are schematic diagrams for explaining a second embodiment of the laser apparatus of the present invention. Elements that are common to the first embodiment are given the same reference numerals and will not be described again. The difference from the first embodiment is the configuration of the wavelength filter.

In FIG. 6A and FIG. 6B, reference numeral 201 denotes the wavelength filter that is formed by three birefringent plates 202-1, 202-2, and 202-3. The birefringent plate 202-1 is made of quartz crystal having the optical axis perpendicular to the thickness direction and a thickness of 0.7 mm (equal to one time the “predetermined thickness”). The birefringent plate 202-2 is made of quartz crystal having the optical axis perpendicular to the thickness direction and a thickness of 2.8 mm (equal to four times the “predetermined thickness”). The birefringent plate 202-3 is made of quartz crystal having the optical axis perpendicular to the thickness direction and a thickness of 1.4 mm (equal to two times the “predetermined thickness”).

The birefringent plates 202-1, 202-2, and 202-3 are all arranged parallel such that light to be output is incident at the Brewster's angle. The optical axes of the plates are oriented in the same direction. Provided that in-plane directions of 0° to 180° of the birefringent plate are parallel to the paper plane, and directions of 90° to 270° are vertical to the paper plane, the birefringent plates are arranged such that their optical axes are oriented in the direction of 32°.

In this embodiment, when light of wavelength 749 nm (“first wavelength”) transmits the birefringent plate 202-1, an ordinary ray and an extraordinary ray have a phase difference of an even multiple of 180°. When light of wavelength 799 nm (“second wavelength”) transmits the birefringent plate, an ordinary ray and an extraordinary ray have a phase difference of an odd multiple of 180°.

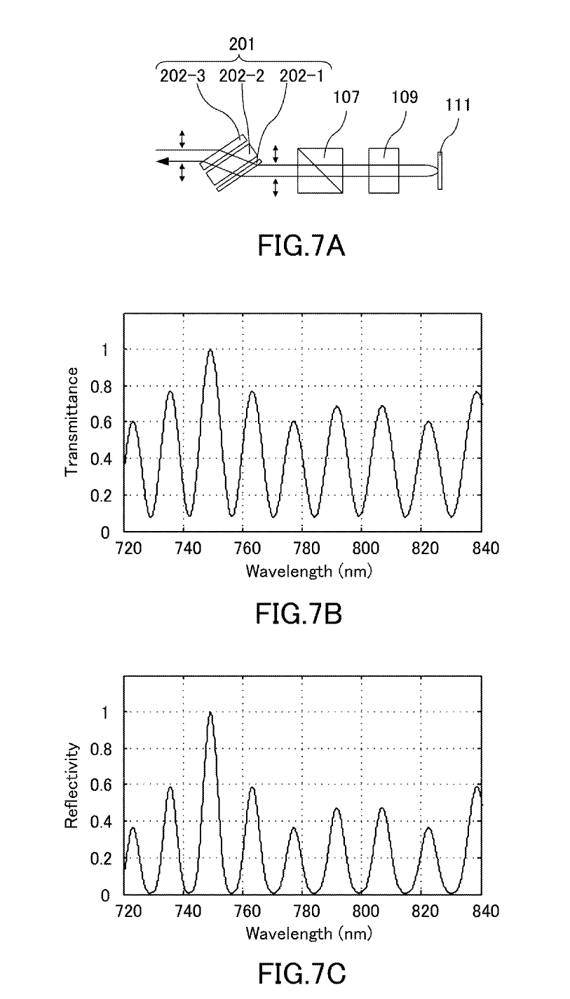

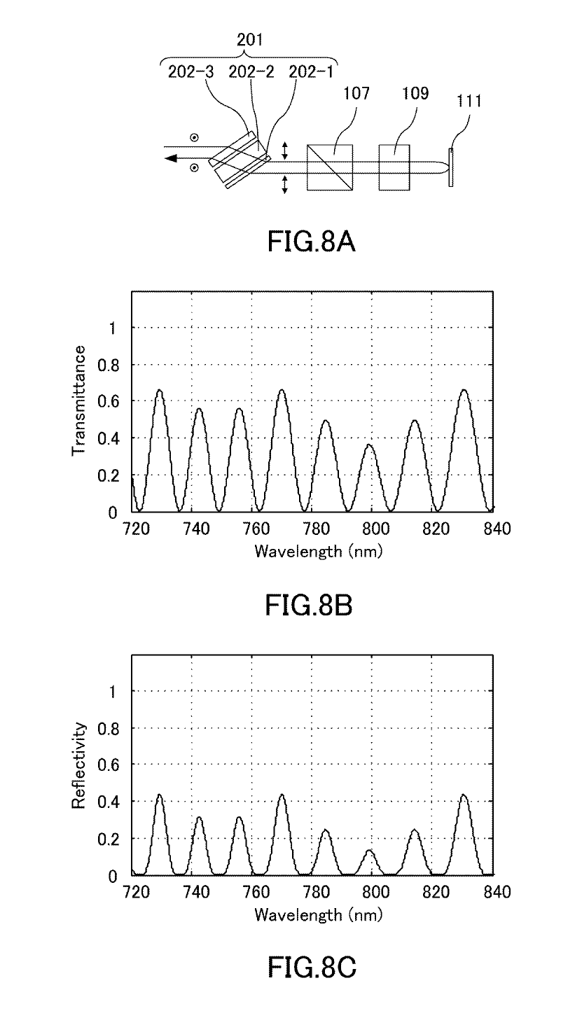

FIG. 6A is a schematic diagram of a state in which the first light shielding means 109 is open and the second light shielding means 113 is closed. The properties the wavelength filter 201 exhibits at this time will be described with reference to FIGS. 7A to 7C and FIGS. 8A to 8C.

FIG. 7A shows part of FIG. 6A. FIG. 7B shows the power transmittance of p-polarized light through the wavelength filter 201 when p-polarized light is incident from the left side of the wavelength filter 201 in FIG. 7A. FIG. 7C shows the power reflectivity of p-polarized light that has entered the wavelength filter 201, traveled via the polarizing beam splitting element 107 and the first rear mirror 111, and is emitted from the wavelength filter 201.

FIGS. 7B and 7C indicate that light of a wavelength of 749 nm can resonate most efficiently.

FIG. 8A shows part of FIG. 6A. FIG. 8B shows the power transmittance of p-polarized light through the wavelength filter 201 when s-polarized light is incident from the left side of the wavelength filter 201 in FIG. 8A. FIG. 8C shows the power reflectivity of s-polarized light that has entered the wavelength filter 201, traveled via the polarizing beam splitting element 107 and the first rear mirror 111, and is emitted from the wavelength filter 201.

FIG. 8B and FIG. 8C indicate that an s-polarized light beam of around 770 nm, for example, can resonate, but since the reflectivity is about 40%, the oscillation threshold is higher than the case shown in FIGS. 7A to 7C. The laser medium (crystal) 101 has an end face processed to be at the Brewster's angle, so that the reflection loss of s-polarized light is higher than that of p-polarized light.

Accordingly, in the state shown in FIG. 6A, a laser beam of around 749 nm is output.

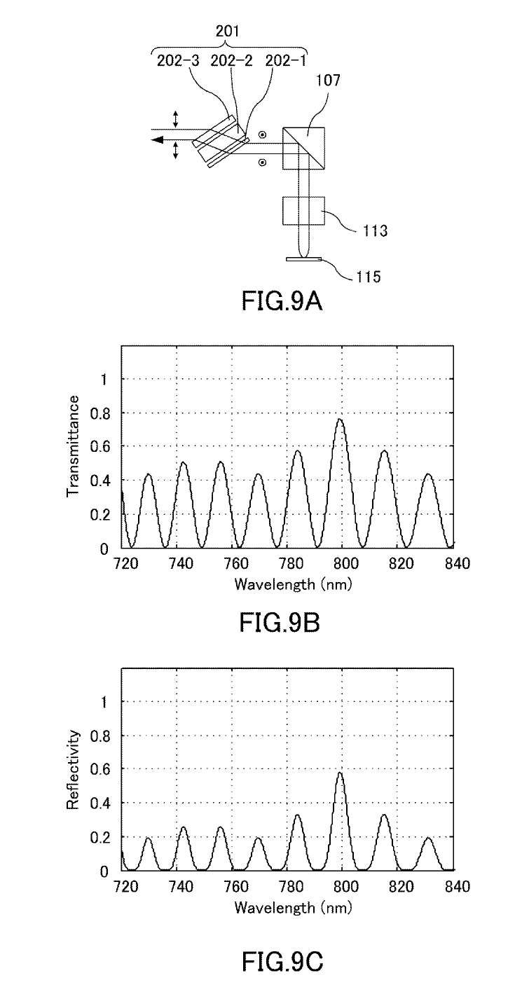

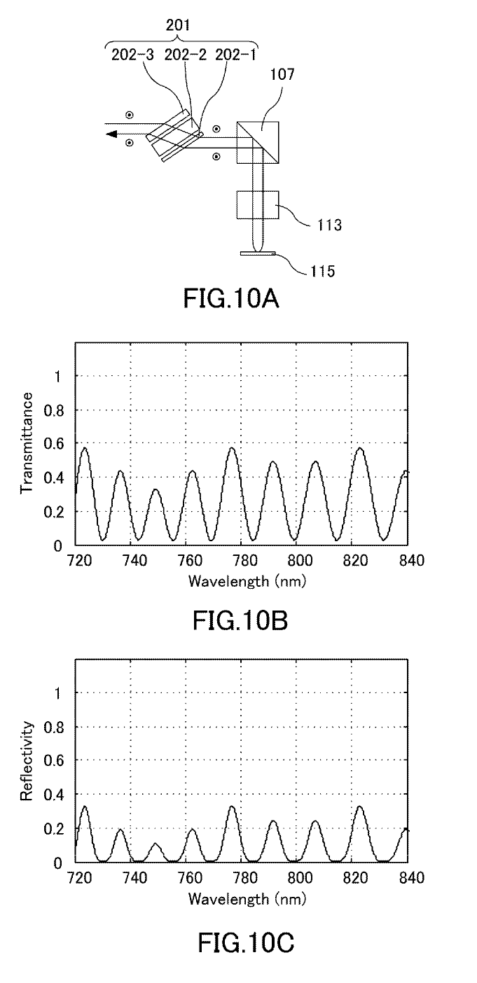

FIG. 6B is a schematic diagram of a state in which the first light shielding means 109 is closed and the second light shielding means 113 is open. The properties the wavelength filter 201 exhibits at this time will be described with reference to FIGS. 9A to 9C and FIGS. 10A to 10C.

FIG. 9A shows part of FIG. 6B. FIG. 9B shows the power transmittance of s-polarized light through the wavelength filter 201 when p-polarized light is incident from the left side of the wavelength filter 201 in FIG. 9A. FIG. 9C shows the power reflectivity of p-polarized light that has entered the wavelength filter 201, traveled via the polarizing beam splitting element 107 and the second rear mirror 115, and is emitted from the wavelength filter 201.

FIGS. 9B and 9C indicate that light of wavelength 799 nm can resonate most efficiently.

FIG. 10A shows part of FIG. 6B. FIG. 10B shows the power transmittance of s-polarized light through the wavelength filter 201 when s-polarized light is incident from the left side of the wavelength filter 201 in FIG. 10A. FIG. 10C shows the power reflectivity of s-polarized light that has entered the wavelength filter 201, traveled via the polarizing beam splitting element 107 and the second rear mirror 115, and is emitted from the wavelength filter 201.

FIG. 10B and FIG. 10C indicate that an s-polarized light beam of around 777 nm, for example, can resonate, but since the reflectivity is about 30%, the oscillation threshold is higher than the case shown in FIGS. 9A to 9C. The laser medium (crystal) 101 has an end face processed to be at the Brewster's angle, so that the reflection loss of s-polarized light is higher than that of p-polarized light.

Accordingly, in the state shown in FIG. 6B, a laser beam of around 799 nm is output.

As described above, two wavelengths (749 nm and 799 nm) can be switched between one another only by opening and closing the first and second light shielding means 109 and 113.

A comparison between FIG. 7C and FIG. 9C shows that the reflectivity of light of wavelength 749 nm from the first cavity is higher than the reflectivity of light of wavelength 799 nm from the second cavity, i.e., the oscillation threshold is lower. Generally, a higher gain is obtained with light of wavelength 799 nm than with light of wavelength 749 nm in a laser that uses titanium sapphire crystal. In this embodiment, therefore, the reflectivity is set to be lower for the light of a wavelength with which a higher gain is obtained, so as to reduce the difference in laser output between the two wavelengths.

In this embodiment, the first wavelength and the second wavelength can be shifted between one another with the difference therebetween kept to be about 50 nm, by rotating the wavelength filter 201 around an axis perpendicular to the plate surface of the birefringent plate. This equals to controlling the direction of the optical axes of the birefringent plates. While the wavelength filter needs to be rotated for adjustment of wavelength, it is kept stationary and need not be moved when laser pulses are actually output or wavelengths are switched. Since the difference between the first and second wavelengths is determined by the thickness of the birefringent plate that forms the wavelength filter, plates with a smaller thickness may be selected if the wavelength difference is desired to be larger, and plates with a larger thickness may be selected if the wavelength difference is desired to be smaller. Namely, two wavelengths of light to be emitted can be freely selected by suitably selecting the direction of optical axes or the thicknesses of the birefringent plates that form the wavelength filter.

### Embodiment 3

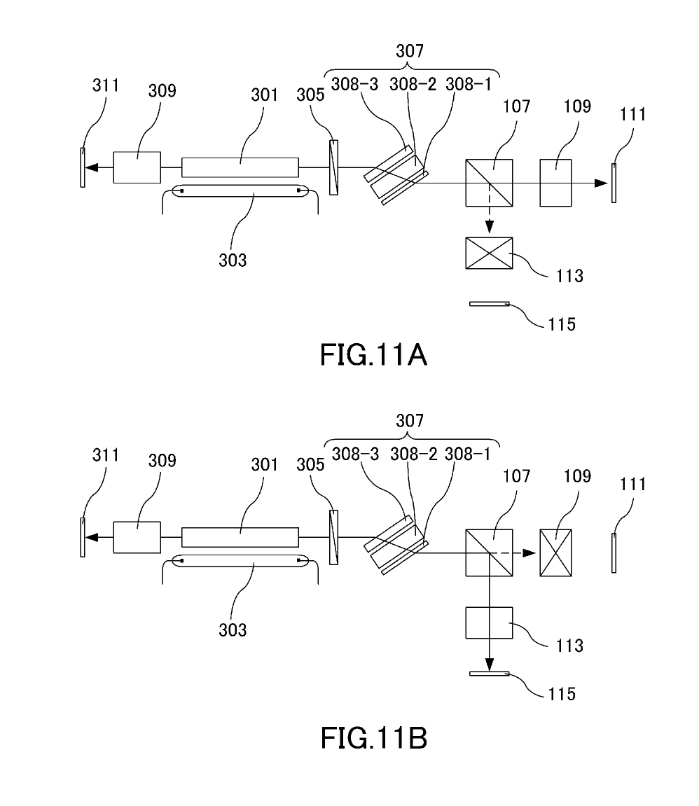

FIGS. 11A and 11B are schematic diagrams for explaining a third embodiment of the laser apparatus of the present invention. Elements that are common to the first embodiment are given the same reference numerals and will not be described again. The difference from the first embodiment is the configurations of the wavelength filter and the laser medium.

In FIG. 11A and FIG. 11B, reference numeral 301 denotes a laser medium made of alexandrite crystal arranged to have its b-axis oriented in the up and down direction of the paper plane, and having anti-reflection coating on both end faces (not shown). Reference numeral 303 denotes a flash lamp for pumping the laser medium 301. Light emission from the flash lamp 303 is controlled by a pulsed power source (not shown). Reference numeral 305 denotes a polarizing plate that transmits only p-polarized light (that has an electric field in the direction parallel to the paper plane).

Reference numeral 307 denotes a wavelength filter that is formed by three birefringent plates 308-1, 308-2, and 308-3. The birefringent plate 308-1 is made of quartz crystal having the optical axis perpendicular to the thickness direction and a thickness of 0.7 mm (equal to one time the “predetermined thickness”). The birefringent plate 308-2 is made of quartz crystal having the optical axis perpendicular to the thickness direction and a thickness of 2.8 mm (equal to four times the “predetermined thickness”). The birefringent plate 308-3 is made of quartz crystal having the optical axis perpendicular to the thickness direction and a thickness of 1.4 mm (equal to two times the “predetermined thickness”).

The birefringent plates 308-1, 308-2, and 308-3 are all arranged parallel such that light to be output is incident at the Brewster's angle. The optical axes of the plates are oriented in the same direction. Provided that in-plane directions of 0° to 180° of the birefringent plate are parallel to the paper plane, and directions of 90° to 270° are vertical to the paper plane, the birefringent plates are arranged such that their optical axes are oriented in the direction of 42.5°.

In this embodiment, when light of wavelength 798 nm (“first wavelength”) transmits the birefringent plate 308-1, an ordinary ray and an extraordinary ray have a phase difference of an even multiple of 180°. When light of wavelength 751 nm (“second wavelength”) transmits the birefringent plate, an ordinary ray and an extraordinary ray have a phase difference of an odd multiple of 180°. Reference numeral 309 denotes a Q-switch, and reference numeral 311 denotes an output coupler having a reflectivity of 50%.

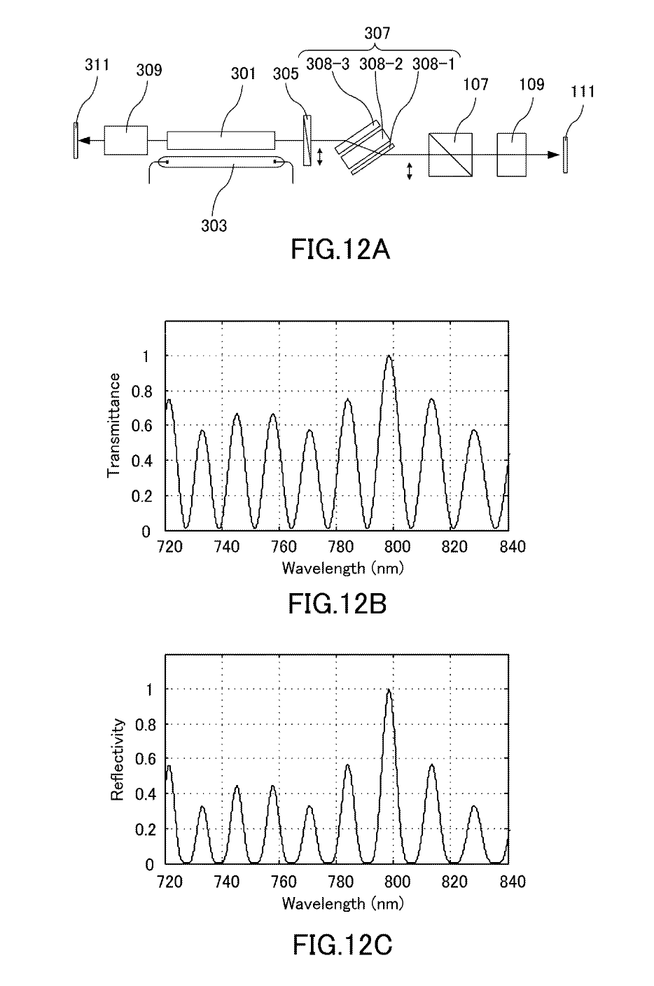

FIG. 11A is a schematic diagram of a state in which the first light shielding means 109 is open and the second light shielding means 113 is closed. The properties the wavelength filter 307 exhibits at this time will be described with reference to FIGS. 12A to 12C.

FIG. 12A shows part of FIG. 11A. FIG. 12B shows the power transmittance of p-polarized light through the wavelength filter 307 when p-polarized light is incident from the left side of the wavelength filter 307 in FIG. 12A. FIG. 12C shows the power reflectivity of p-polarized light that has entered the wavelength filter 307, traveled via the polarizing beam splitting element 107 and the first rear mirror 111, and is emitted from the wavelength filter 307.

FIGS. 12B and 12C indicate that light of wavelength 798 nm can resonate most efficiently.

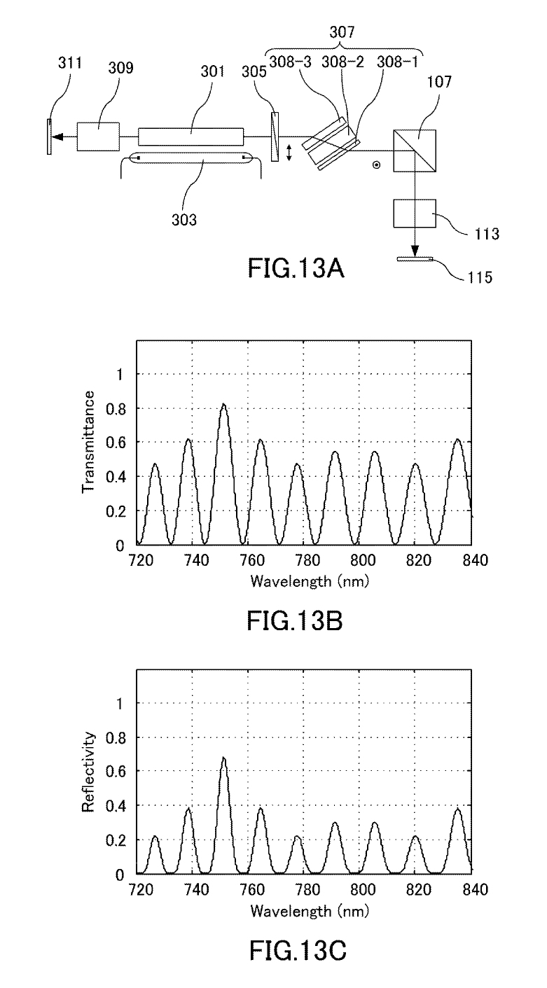

FIG. 11B is a schematic diagram of a state in which the first light shielding means 109 is closed and the second light shielding means 113 is open. The properties the wavelength filter 307 exhibits at this time will be described with reference to FIGS. 13A to 13C.

FIG. 13A shows part of FIG. 11B. FIG. 13B shows the power transmittance of s-polarized light through the wavelength filter 307 when p-polarized light is incident from the left side of the wavelength filter 307 in FIG. 13A. FIG. 13C shows the power reflectivity of p-polarized light that has entered the wavelength filter 307, traveled via the polarizing beam splitting element 107 and the second rear mirror 115, and is emitted from the wavelength filter 307.

FIGS. 13B and 13C indicate that light of wavelength 751 nm can resonate most efficiently.

The two wavelengths (798 nm and 751 nm) can be switched from one another by controlling the first and second light shielding means 109 and 113 to open and close, and controlling the ON/OFF of the Q switch 309 in synchronism with the current pulses applied to the flash lamp 303.

A comparison between FIG. 12C and FIG. 13C shows that the reflectivity of light of wavelength 798 nm from the first cavity is higher than the reflectivity of light of wavelength 751 nm from the second cavity, i.e., the oscillation threshold is lower. Generally, a higher gain is obtained with light of wavelength 751 nm than with light of wavelength 798 nm in a laser that uses alexandrite crystal. In this embodiment, therefore, the reflectivity is set to be lower for the light of a wavelength with which a higher gain is obtained, so as to reduce the difference in laser output between the two wavelengths.

In this embodiment, similarly to the second embodiment, two wavelengths of light to be emitted can be freely selected by suitably selecting the direction of optical axes or the thicknesses of the birefringent plates that form the wavelength filter.

It is known that a larger gain is achieved for light having an electric field component in the direction of the b-axis than light having an electric field component in the direction orthogonal thereto. Since the configuration of this embodiment is designed such that p-polarized light is oscillated dominantly, the polarizing plate 305 may be omitted. The polarizing plate 305 is effective in preventing abnormal oscillation in higher power output.

While a Q switch is used in this embodiment, long pulses with an amplitude of about 100 μsec can be emitted even without a Q switch. In this case, the two wavelengths can be switched from one another by controlling the first and second light shielding means 109 and 113 to open and close in synchronism with the current pulses applied to the flash lamp 303.

### Embodiment 4

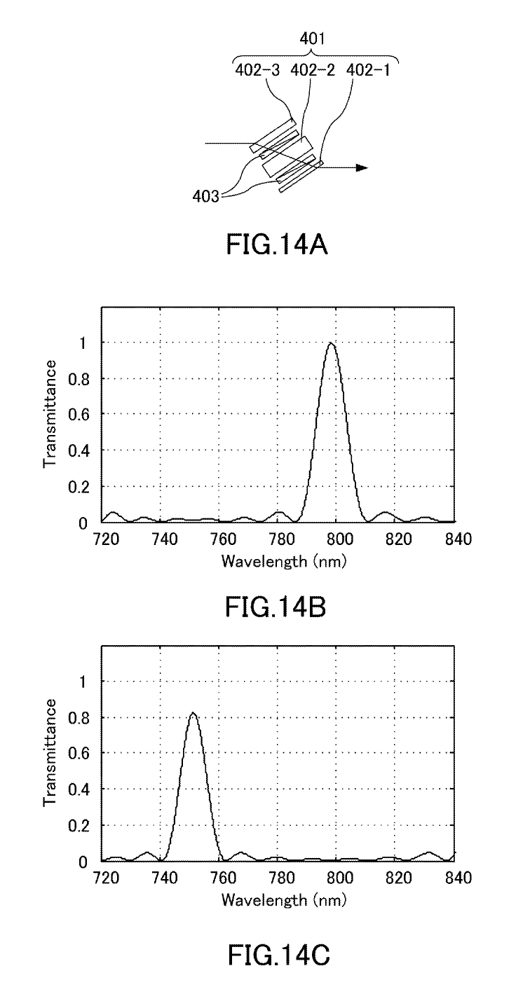

FIG. 14A is a schematic diagram for explaining a fourth embodiment of the laser apparatus of the present invention. Description of the basic configuration will be omitted as it is the same as that of the third embodiment except for the wavelength filter.

In the drawing, reference numeral 401 denotes a wavelength filter that is formed by three birefringent plates 402-1, 402-2, and 402-3, and two polarizing plates 403. The birefringent plate 402-1 is made of quartz crystal having the optical axis perpendicular to the thickness direction and a thickness of 0.7 mm (equal to one time the “predetermined thickness”). The birefringent plate 402-2 is made of quartz crystal having the optical axis perpendicular to the thickness direction and a thickness of 2.8 mm (equal to four times the “predetermined thickness”). The birefringent plate 402-3 is made of quartz crystal having the optical axis perpendicular to the thickness direction and a thickness of 1.4 mm (equal to two times the “predetermined thickness”).

The birefringent plates 308-1, 308-2, and 308-3 are all arranged parallel such that light to be output is incident at the Brewster's angle. The optical axes of the plates are oriented in the same direction. Provided that in-plane directions of 0° to 180° of the birefringent plate are parallel to the paper plane, and directions of 90° to 270° are vertical to the paper plane, the birefringent plates are arranged such that their optical axes are oriented in the direction of 42.5°. The polarizing plates 403 are arranged between the birefringent plates such as to transmit only p-polarized light that has an electric field in the direction parallel to the paper plane.

FIG. 14B shows the power transmittance of p-polarized light through the wavelength filter 401 when p-polarized light is incident from the left side of the wavelength filter 401 in FIG. 14A. FIG. 14C shows the power transmittance of s-polarized light of the wavelength filter 401 when p-polarized light is incident from the left side of the wavelength filter 401 in FIG. 14A.

A comparison between FIG. 14A and FIG. 12B, and FIG. 14C and FIG. 13B, shows that side lobes of the transmission spectrum are minimized in this embodiment.

Similarly to the third embodiment, the two wavelengths (798 nm and 751 nm) can be switched from one another by controlling the first and second light shielding means 109 and 113 to open and close, and controlling the ON/OFF of the Q switch 309.

This embodiment is effective for wavelength stabilization and prevention of abnormal oscillation in high power output, as the side lobes of the transmission spectrum of the wavelength filter are minimized.

In the first to fourth embodiments described above, the wavelength filter is formed by three birefringent plates having a thickness of 0.7 mm, 2.8 mm, and 1.4 mm, respectively, but the number or thickness of the birefringent plates are not limited to these and may be selected in accordance with the necessary spectral width. The thickness of the birefringent plate closest to the polarizing beam splitting element may be an odd multiple of a desired thickness. The thickness of other birefringent plates may be an even multiple of the desired thickness.

### Embodiment 5

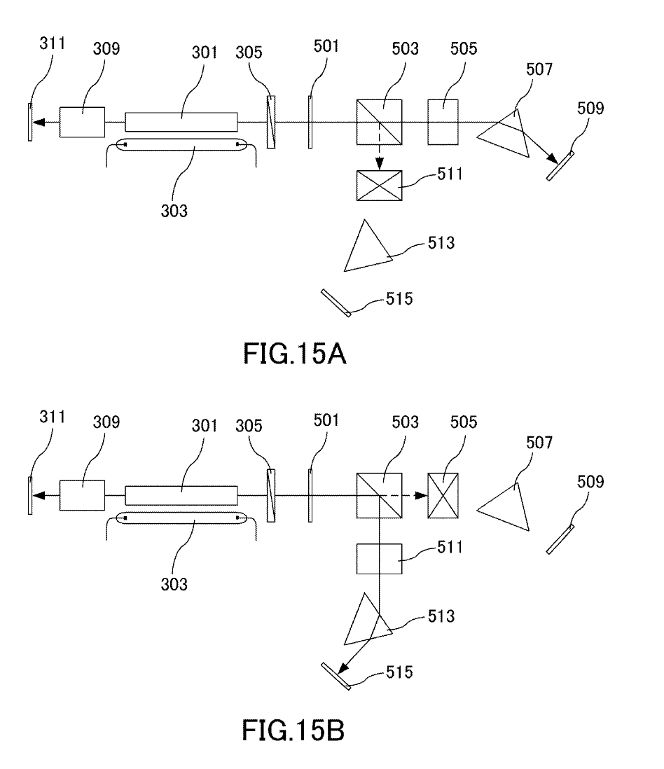

FIGS. 15A and 15B are schematic diagrams for explaining a fifth embodiment of the laser apparatus of the present invention. Elements that are common to the third embodiment are given the same reference numerals and will not be described again. The difference from the third embodiment is the configurations of the wavelength filter and the separate parts of the first and second cavities (first and second separate parts).

Reference numeral 501 in FIGS. 15A and 15B denotes a wavelength filter. Reference numeral 503 denotes a polarizing beam splitting element which is a polarizing beam splitter that transmits p-polarized light and reflects s-polarized light. Reference numeral 505 denotes first light shielding means which is an optical shutter provided to the first cavity. Reference numeral 507 denotes a first dispersion prism, and reference numeral 509 denotes a first rear mirror that has a reflectivity of 99%. Reference numeral 511 denotes second light shielding means which is an optical shutter provided to the second cavity. Reference numeral 513 denotes a second dispersion prism, and reference numeral 515 denotes a second rear mirror that has a reflectivity of 99%.

The properties of the wavelength filter 501 will be descried in more detail below.

The wavelength filter 501 is made of quartz crystal having the optical axis perpendicular to the thickness direction and a thickness of 0.7 mm (equal to one time the “predetermined thickness”). When light of wavelength 799 nm (“first wavelength”) transmits the wavelength filter 501, an ordinary ray and an extraordinary ray have a phase difference of an even multiple of 180°, and when light of wavelength 752 nm (“second wavelength”) transmits the birefringent plate, an ordinary ray and an extraordinary ray have a phase difference of an odd multiple of 180°. Provided that the direction parallel to the paper plane is the electric field direction of p-polarized light, covering the angles from 0° to 180°, and the direction vertical to the paper plane is the electric field direction of s-polarized light, covering the angles from 90° to 270°, the wavelength filter 501 is arranged such that its optical axis is oriented in the direction of 45°. The wavelength filter 501 has anti-reflection coating (not shown) on both faces.

FIG. 15A is a schematic diagram of a state in which the first light shielding means 505 is open and the second light shielding means 511 is closed. FIG. 15B is a schematic diagram of a state in which the first light shielding means 505 is closed and the second light shielding means 511 is open.

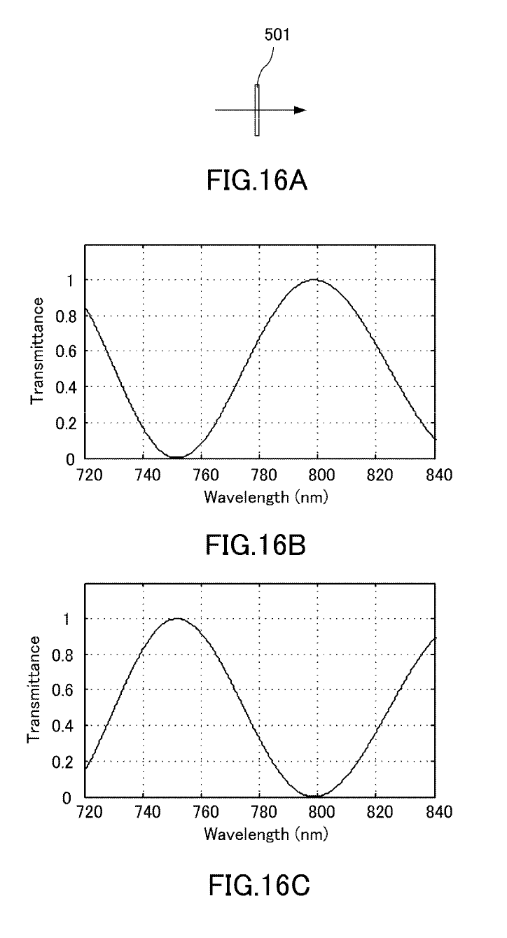

FIG. 16A shows part of FIG. 15A. FIG. 16B shows the power transmittance of p-polarized light through the wavelength filter 501 when p-polarized light is incident from the left side of the wavelength filter 501 in FIG. 16A. FIG. 16C shows the power transmittance of s-polarized light of the wavelength filter 501 when p-polarized light is incident from the left side of the wavelength filter 501 in FIG. 16A.

FIG. 16B shows that the oscillation threshold is lower for the light near wavelength 799 nm in the state of FIG. 15A. FIG. 16C shows that the oscillation threshold is lower for the light near wavelength 752 nm in the state of FIG. 15B.

In this embodiment, as the wavelength filter 501 has a broad transmission spectrum, a first reflection mechanism consisting of the first dispersion prism 507 and the first rear mirror 509 is provided in the separate part of the first cavity so that light of wavelength 799 nm is selectively reflected. A second reflection mechanism consisting of the second dispersion prism 513 and the second rear mirror 515 is provided in the separate part of the second cavity so that light of wavelength 752 nm is selectively reflected. The angles of the first rear mirror 509 and the second rear mirror 515 are adjusted so that light of a desired wavelength is efficiently reflected.

With the configuration described above, the two wavelengths can be switched from one another by controlling the first and second light shielding means 505 and 511 to open and close, and controlling the ON/OFF of the Q switch 309 in synchronism with the current pulses applied to the flash lamp 303.

### Embodiment 6

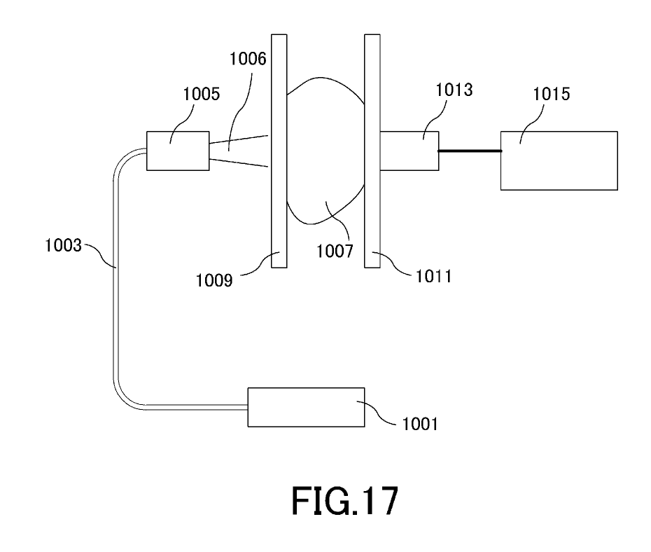

FIG. 17 shows an example of a photoacoustic apparatus having a laser apparatus according to the present invention incorporated therein.

In the drawing, reference numeral 1001 denotes the laser apparatus that uses alexandrite crystal as shown in the third embodiment. Reference numeral 1003 denotes light transmission means formed by a fiber bundle, and reference numeral 1005 denotes light emission means. Reference numeral 1007 denotes an object, and reference numerals 1009 and 1011 denote holder plates for holding the object therebetween. The holder plates 1009 and 1011 are made of polymethylpentene resin with a thickness of 10 mm, for example. Reference numeral 1013 denotes an acoustic wave detector having a two-dimensional array of sensor elements. Reference numeral 1006 denotes a light beam emitted from the light emission means 1005. An optical system (not shown) provided inside the light emission means 1005, such as lenses, is adjusted so that a desired area of the object 1007 is irradiated with the light beam 1006 in front of the acoustic wave detector 1013. The space between the acoustic wave detector 1013 and the holder plate 1011 is filled with water to facilitate propagation of acoustic waves (not shown).

The laser apparatus 1001 in this embodiment is configured to be capable of emitting laser pulses at two wavelengths, 798 nm and 751 nm, with an amplitude of about 50 nsec and an energy of about 200 mJ.

The acoustic wave detector 1013 uses a two-dimensional, 10×15, array of 2 mm square, 2 mm pitch piezoelectric transducers and has a central detection frequency of 1 MHz.

The signals sequentially received by the acoustic wave detector 1013 are converted into a photoacoustic image of the inside of the object by a signal processing unit 1015 using, for example, a delay-and-sum algorithm. The photoacoustic image may be displayed on a monitor (not shown) to allow the operator to observe the image.

This photoacoustic image represents a sound pressure distribution inside the object. Since sound pressure is proportional to light absorption, processing and comparison of two photoacoustic images obtained from light of two wavelengths allow identification of segments inside the object with a strongly wavelength-dependent absorption rate and segments with a less wavelength-dependent absorption rate.

A sample simulating a living body was used as the object 1007, in which a blood vessel phantom with oxyhemoglobin and deoxyhemoglobin was embedded to a depth of 30 mm from the surface. Light pulses of wavelengths 798 nm and 751 nm were alternately emitted from the laser apparatus 1001 at a repetition frequency of 20 Hz. Two photoacoustic images thus obtained were processed and compared, as a result of which a difference in the oxyhemoglobin concentration was visualized.

The photoacoustic apparatus of this embodiment could be applied for measurement of a living body such as abreast to obtain a highly accurate image, as the effects of movement caused by aspiration or pulsation can be canceled out by changing the wavelength per each pulse.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-246411, filed on Nov. 8, 2012, which is hereby incorporated by reference herein in its entirety.

What is claimed is:

1. A laser apparatus comprising:
a cavity having an output unit, and a branch unit arranged between the output unit and first and second reflection units, an optical path in the cavity including a common part between the output unit and the branch unit and separate parts between the branch unit and the first and second reflection units, respectively;
a laser medium and a wavelength filter disposed in the common part;
a pump unit configured to pumping the laser medium; and
first and second shielding units respectively disposed in the first and second separate parts configured to allowing selection of one of a first wavelength and a second wavelength of light to be emitted,
the wavelength filter having a higher transmittance of first polarized light than second polarized light when the first polarized light of the first wavelength is incident, and a lower transmittance of the first polarized light than the second polarized light when the first polarized light of the second wavelength is incident,
the branch unit splits a light beam into the first polarized light and the second polarized light, and
one of the first and second shielding units being opened and the other closed to select one of the wavelengths of light to be emitted.

2. The laser apparatus according to claim 1, wherein the first polarized light is p-polarized light, and the second polarized light is s-polarized light perpendicular to the first polarized light.

3. The laser apparatus according to claim 2, wherein the branch unit is a polarizing beam splitting element that splits a light beam into p-polarized light that is the first polarized light and s-polarized light that is the second polarized light.

4. The laser apparatus according to claim 1, wherein the wavelength filter is formed by a birefringent plate having a predetermined thickness.

5. The laser apparatus according to claim 1, wherein the wavelength filter is formed by a plurality of birefringent plates, one of the birefringent plates located closest to the branch unit having a thickness that is an odd multiple of a predetermined thickness, and other birefringent plates having a thickness that is an even multiple of the predetermined thickness.

6. The laser apparatus according to claim 5, wherein a polarizing plate that transmits the first polarized light is inserted between the plurality of birefringent plates forming the wavelength filter.

7. The laser apparatus according to claim 4, wherein the predetermined thickness is set such that an ordinary ray and an extraordinary ray of the first wavelength propagating through the birefringent plate have a phase difference of an even multiple of 180°, and that an ordinary ray and an extraordinary ray of the second wavelength have a phase difference of an odd multiple of 180°.

8. The laser apparatus according to claim 4, wherein the birefringent plate forming the wavelength filter is arranged such that light is incident perpendicularly.

9. The laser apparatus according to claim 8, wherein the birefringent plate forming the wavelength filter has anti-reflection coating on both faces.

10. The laser apparatus according to claim 4, wherein the birefringent plate forming the wavelength filter is arranged such that light is incident at a Brewster's angle.

11. The laser apparatus according to claim 10, wherein the wavelength filter is capable of rotating around an axis perpendicular to a plate surface of the birefringent plate, this rotation of the wavelength filter enabling the first wavelength and the second wavelength to be shifted between one another with a difference therebetween maintained constant.

12. The laser apparatus according to claim 5, wherein the birefringent plates forming the wavelength filter are made of uniaxial crystal processed to have an optical axis parallel to a plate surface, the plurality of birefringent plates respectively having optical axes oriented in the same direction.

13. The laser apparatus according to claim 1, wherein a first reflection mechanism selectively reflecting light of the first wavelength is provided in the first separate part, and a second reflection mechanism selectively reflecting light of the second wavelength is provided in the second separate part.

14. The laser apparatus according to claim 13, wherein the first reflection mechanism is formed of a first dispersion prism and a first mirror arranged at an angle that is adjusted to reflect light of the first wavelength, and
the second reflection mechanism is formed of a second dispersion prism and a second mirror arranged at an angle that is adjusted to reflect light of the second wavelength.

15. A photoacoustic apparatus, comprising:
the laser apparatus according to claim 1;
an acoustic wave detector receiving an acoustic wave generated from an object irradiated with light emitted from the laser apparatus; and
a signal processing unit obtaining information of inside of the object from the acoustic wave.

16. The photoacoustic apparatus according to claim 15, wherein the first and second wavelengths respectively correspond to absorption characteristics of oxyhemoglobin and deoxyhemoglobin.

17. The photoacoustic apparatus according to claim 16, wherein the information of inside of the object is oxygen saturation.
